(19) United States
(12) Patent Application Publication
(10) Pub. No.: US 2008/0232927 A1
(43) Pub. Date: Sep. 25, 2008

(54) Protective cap

(75) Inventors: Matthew G. Trimble, Erie, PA (US); Daniel J. Steffan, Erie, PA (US)

Correspondence Address: OLIFF & BERRIDGE, PLC, P.O. BOX 320850, ALEXANDRIA, VA, 22320-4850, US

(73) Assignee: ALLIANCE PLASTICS, ERIE, PA (US)

(21) Appl. No.: 11/723,884

(22) Filed: Mar. 22, 2007

(51) Int. Cl. F16B 37/14

(52) U.S. Cl. 411/429

(57) ABSTRACT

A protective cap for a threaded valve stem has a protective end, an open end, and a wall between the protective end and the open end. The wall has an internal surface and may have a plurality of ribs located on the internal surface, wherein the ribs have a tapered portion facing the open end for use in guiding the threaded valve stem into the center of the protective cap as it is inserted. The protective cap also has a plurality of projections connected to the internal surface of the wall for engaging the external threads of the valve stem, to prevent easy removal of the cap. The protective end and/or the wall also has a plurality of vent openings.

This application relates to a protective cap for covering an opening of a structure such as a threaded valve stem. In particular, the application relates to a protective cap for a propane gas tank valve stem, that provides the purchaser with a convenient visual identification that the tank is full and has not been tampered with.

Conventionally, for propane valves, plastic caps are used to protect the valve stem opening after a propane tank has been filled, and to indicate that the propane tank is full and has not been used.

U.S. Pat. No. 4,779,750 to Steffan and U.S. Pat. No. 7,152,760 to Peabody disclose tamper indicating caps. The respective caps comprise a protective top, an open bottom, and a side connecting the top and the bottom. The side has a tear strip and a plurality of radially inwardly extending projections for securely engaging the cap onto a valve stem of a propane tank.

### SUMMARY

This invention provides a protective cap that can be used on various types of openings, and that provides various advantages relative to the prior caps described above.

Exemplary embodiments provide a protective cap usable to protect a threaded valve stem including an external thread. The cap comprises a protective end, an open end, and a wall between the protective end and the open end. A plurality of ribs are located on the internal surface of the wall, the ribs having a tapered portion facing the open end for use in easily centering the threaded valve stem.

A plurality of projections are provided, the projections having first and second ends, with the first ends being connected to the internal surface of the wall and the second ends engaging the external thread so that the projections prevent easy removal of the cap. Preferably, at least two ribs are located on the internal surface of the wall intermediate adjacent projections. This aids structural strength of the wall, and facilitates the use of vent openings intermediate adjacent pairs of the ribs to enhance venting of fluids that may be released from valve prior to removal of the cap.

The protective end may comprise a central portion that completely covers the circular opening of the valve, and an outer vent portion that forms a plurality of vent openings to enhance venting. The wall between the protective end and the open end may have a tear strip portion and a vent portion. The tear strip portion may be defined by at least one, and preferably a pair, of frangible members extending between the protective end and the open end to define a tear strip. The vent portion forms a plurality of vent openings to enhance venting. In some embodiments, at least 20%, up to about 50%, of the protective end is occupied by the vent openings.

These and other objects, advantages and salient features are described in or apparent from the following detailed description of exemplary embodiments.

### BRIEF DESCRIPTION OF THE DRAWINGS

Exemplary embodiments of the invention will be described with reference to the following drawings, which are proportionally accurate, wherein like numerals represent like parts, and wherein:

FIG. 1 is a perspective view of an exemplary embodiment of a protective cap;

FIG. 2 is a bottom view of an exemplary embodiment of a protective cap, viewed from an open end of the protective cap;

FIG. 3 is a cross sectional view of the exemplary embodiment of a protective cap viewed along the line 3-3 shown in FIG. 2;

FIG. 4 is a bottom view of an exemplary embodiment of a protective cap, viewed from a protective end of the protective cap;

FIG. 5 is a top view of a protective end of an exemplary embodiment of a protective cap;

FIG. 6 is a side view of an exemplary embodiment of a protective cap attached to a valve;

FIG. 7 is a cross sectional view of the exemplary embodiment of a protective cap attached to a valve, viewed along the line 6-6 shown in FIG. 5;

FIG. 8 is a cross-sectional view of an exemplary embodiment of a protective cap and a valve in an unlocked state;

FIG. 9 is a cross-sectional view of an exemplary embodiment of a protective cap and a valve engaging with each other; and

FIG. 10 is a cross section of an exemplary embodiment of a protective cap and a valve in a locked state.

### DETAILED DESCRIPTION OF EMBODIMENTS

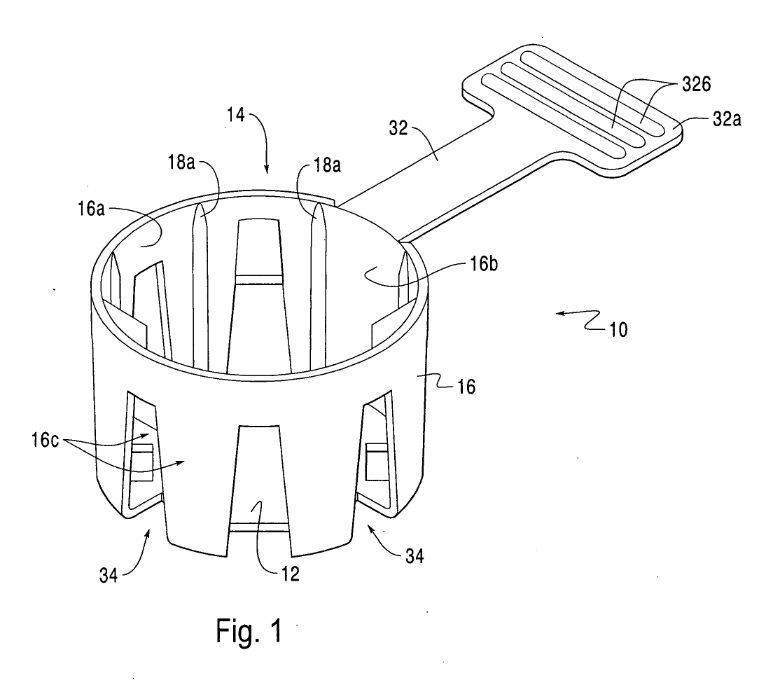

An exemplary embodiment of a protective cap 10 may be made of thermoplastic resin that is injection molded. As shown in FIG. 1, the cap 10 comprises a protective end 12, an open end 14, and a wall 16 between the protective end 12 and the open end 14. The wall 16 may be generally cylindrical and has an internal surface 16a. The wall 16 preferably has a constant diameter but other shapes are acceptable, such as a slightly tapered shape. On the outer surface of the protective end 12, the word “Full,” a warning message and/or safety information or the like may be shown to indicate that the propane tank onto which the cap 10 has been placed is full and has not been tampered with. Of course, the indicia and its location on the cap 10 or tab 32 may be changed from the exemplary embodiments. An exemplary height of the wall 16 is about 27 mm, and an exemplary inner diameter of the open end 14 is about 36 mm, although other values are acceptable for these dimensions.

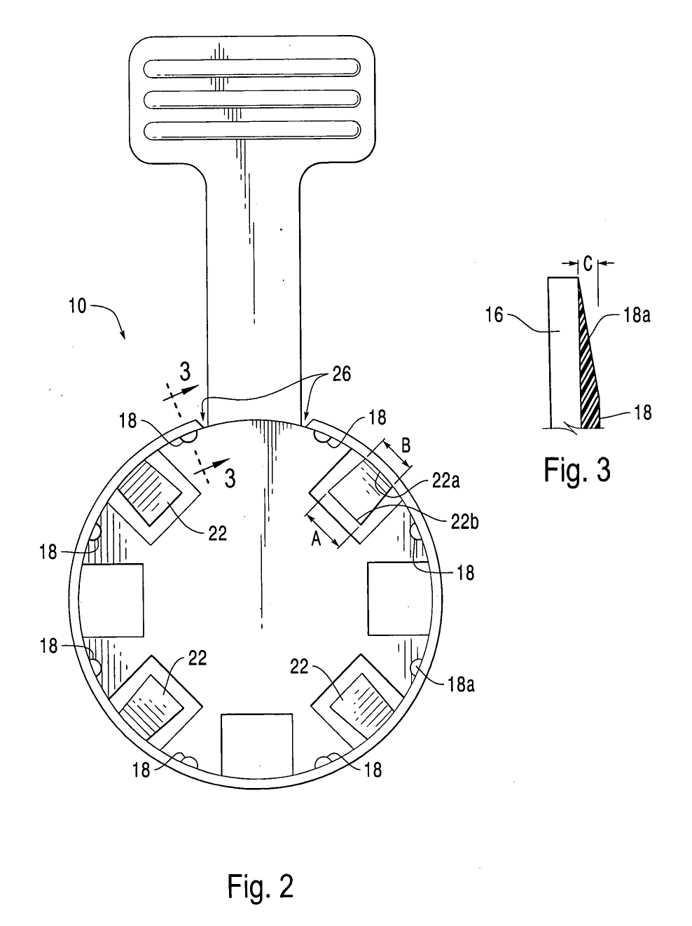

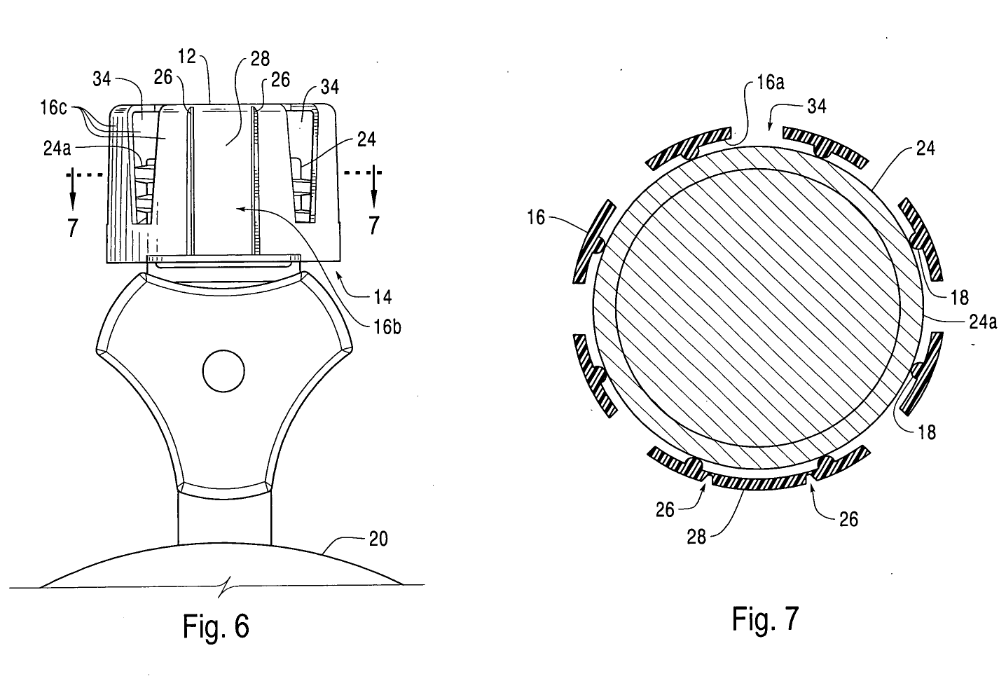

The depicted embodiment also has a plurality of ribs 18 as shown in FIG. 2, located on the internal surface 16a of the wall 16. The ribs 18 preferably, but not necessarily, extend to the open end, and have a tapered portion 18a facing the open end, which guides the threaded valve stem 24 (see FIGS. 6-10) into a central position, so that it is inserted into the center of the protective cap 10. A radial length of the ribs 18, shown as dimension C in FIG. 3, is preferably in a range of from about 0.8 mm to about 5.0 mm. A radial length of from about 0.8 mm to about 2.0 mm, and especially of from about 0.9 mm to about 1.5 mm, such as about 1.0 mm, about 1.1 mm, about 1.2 mm, about 1.3 mm or about 1.4 mm, is particularly advantageous. For example, such a length results in a spacing of the wall 16 from the outer circumference of a valve stem (described below) that provides good venting, but does not use an unnecessarily large amount of material to form the ribs.

The ribs 18 provide strength to the protective cap 10 and facilitate the use of a plurality of vent openings 34, which provide enhanced venting of fluids that may be released from the valve opening 24b after the valve stem 24 has been inserted into the protective cap 10. The vent openings 34 also allow the protective cap 10 to be manufactured utilizing less material than conventional caps with substantially closed protective ends. The tapered portion 18a of the ribs, shown in detail in FIG. 3, allows the valve stem 24 to be inserted easily into the cap 10. The ribs 18 center the valve stem 24 as it is inserted, so that the valve stem 24 engages the plurality of projections 22 in a uniform manner. Without such guiding by the ribs 18, the valve stem 24 could be inserted into the cap 10 in an off-center position, possibly causing overstress and damage to one or more projections 22, which are described hereafter.

The cap 10 has a plurality of projections 22 with first ends 22a and second ends 22b, the first ends 22a being connected to the internal surface 16a of the wall and the second ends 22b projecting radially inward for engaging the external threads 24a of a threaded valve stem 24. In the depicted embodiment, between adjacent projections 22 are at least two ribs 18 located on the internal surface 16a of the wall. The depicted embodiment provides four projections 22 and eight ribs 18, with two of the ribs located on the internal surface 16a of the wall intermediate adjacent ribs 22.

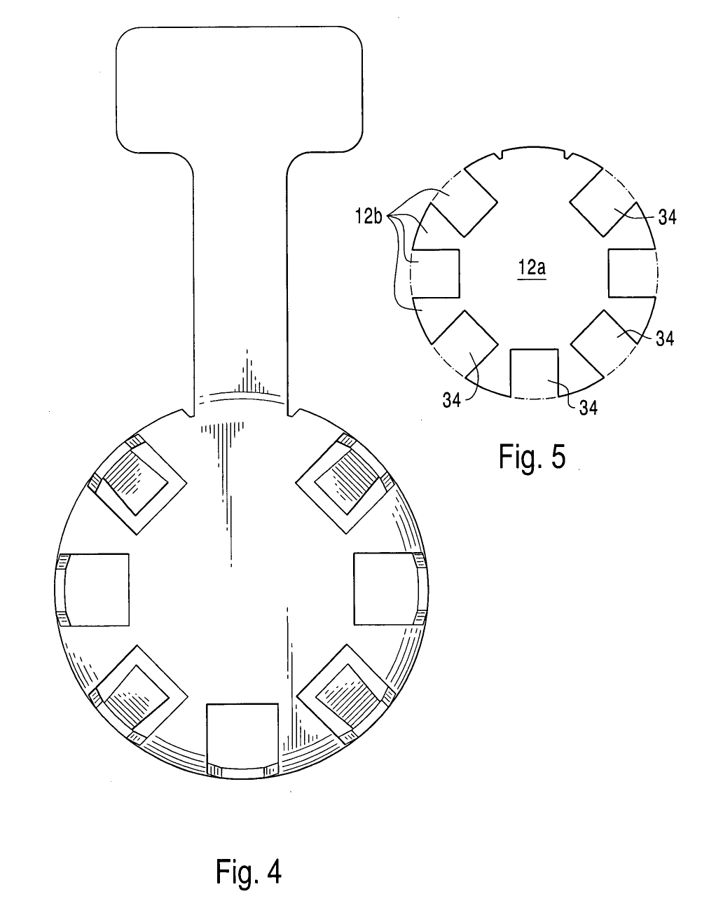

The projections 22 project radially inward from the internal surface of the cylindrical wall 16 and are inclined towards the protective end 12. The projections 22 are flexible to sufficiently bend when the valve stem 24 is inserted into the cap 10. When the cap 10 is engaging a threaded valve stem 24, as shown in FIG. 6, the projections 22 prevent easy removal of the cap 10. As shown in FIGS. 2 and 4, the width A of the second end 22b is greater than the width B of the first end 22a. This may enhance the ability of the projections 22 to grip and lock to the threads 24a of the valve stem. This feature also facilitates design and manufacture of molding dies that may be used to injection mold the cap 10, by making it possible, e.g., for the parts of the upper molding die (not shown) that help form the openings 34 and projections 22 to have a uniformly tapered cross section and simple geometry, as will be appreciated by those skilled in the art when studying the shape of the cap 10.

The depicted embodiment of a cap 10 further comprises a pair of frangible members 26, as shown in FIGS. 1, 6 and 7, located on the wall 16 and extending between the protective end 12 and the open end 14 of the cap 10 to define a tear strip 28. The frangible members 26 are located on the wall 16 intermediate an adjacent pair of ribs 18. The cap 10 also has a pull tab 32 connected to the tear strip 28 at the open end 14 of the cap. After a threaded valve stem 24 is inserted into a cap 10 to place the cap 10 into a locked state in combination with the threaded valve stem 24, the pull tab 32 is used to break the frangible members 26 to enable removal of the cap 10.

The frangible members 26 may be formed on the internal or external surface of the wall 16. Any arrangement of the frangible members 26, or even a single frangible member, is possible to define different shapes of the tear strip 28. Breaking of the frangible members 26 splits the cap 10 for removal from the valve stem 24. Once the frangible members 26 are broken, the cap 10 provides visual evidence of tampering. In the depicted embodiment, the pull tab 32 is formed perpendicular to the wall 16. However, the pull tab 32 may extend in any direction and may also take different forms and shapes. Furthermore, as shown in the exemplary embodiment illustrated in FIG. 1, there may be formed a wide grip portion 32a and/or bumps 32b to enhance gripping by a user. Therefore, by pulling the pull tab 32, the frangible members 26 break, allowing the diameter of the wall 16 to expand. This releases the projections 22 from the valve threads 24a, allowing the protective cap 10 to be removed from the valve stem 24.

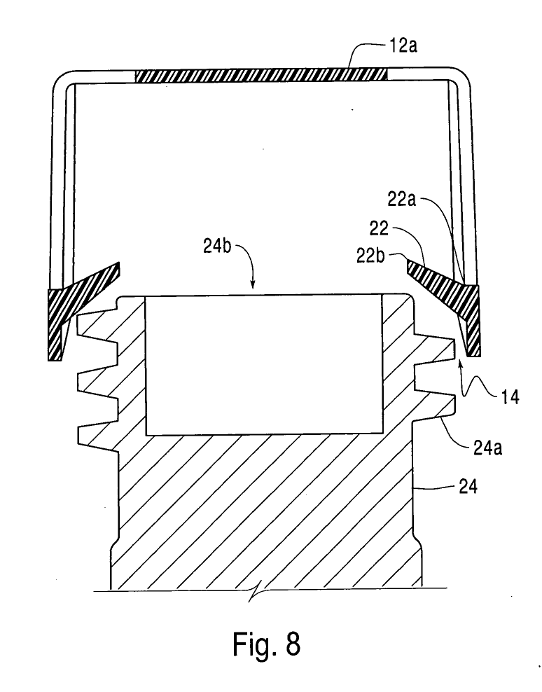

As shown in FIG. 8, the threaded valve stem 24 has a circular opening 24b. The protective end 12 of the cap has a central portion 12a sized for completely covering the circular opening 24b. The central portion 12a may be sized to just barely cover the opening 24b, and may not extend to the outer edge of the wall defining the opening 24b. By so doing, venting may be enhanced. The protective end 12 also has an outer vent portion 12b forming a plurality of vent openings 24. In an exemplary embodiment, as shown in FIGS. 4 and 5, at least 20%, up to about 50%, of the protective end 12 is occupied by vent openings 34.

The wall 16 includes a vent portion 16c that defines a plurality of vent openings 34. Each of the vent openings 34 in the vent portion 16c of the wall is intermediate an adjacent pair of ribs 18. In the depicted embodiment, there are fewer projections 22 than vent portions 16c. Having relatively fewer projections reduces the effort needed to install the cap 10, while having relatively more vent portions 16c increases venting capacity.

FIG. 8 shows the protective cap 10 in an unlocked state in which the valve stem 24 has not been inserted into the protective cap 10. When the valve stem 24 is inserted into the protective cap 10, the threads 24a of the valve slide along the guiding ribs 18. This positions the valve in the center of the protective cap 10 prior to the valve stem 24 engaging the projections 22.

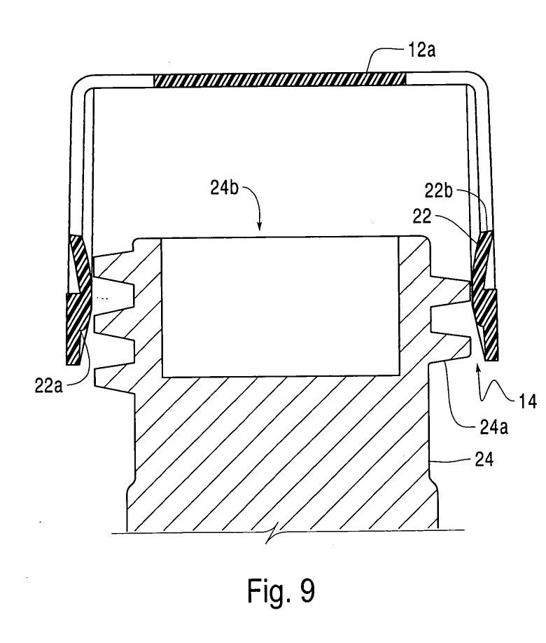

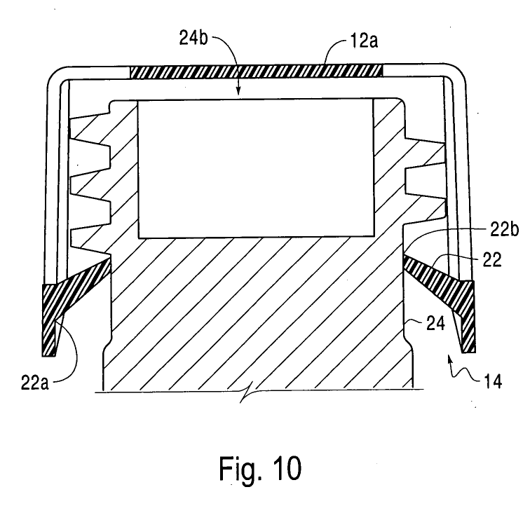

As shown in FIG. 9, the projections are bent radially outward when the threads 24a come over the projections 22 as the valve stem 24 is inserted into the projective cap 10. FIG. 10 shows an embodiment of the cap 10 in a locked state in which the valve stem 24 is fully inserted in the protective cap 10. At this time, all threads 24a have passed the projections 22. The projections 22 may also engage the valve stem 24 between threads 24a in the locked state.

The projections 22 prevent easy removal of the cap, thus providing protection to the opening of the valve 24b from debris and contamination. To remove the protective cap 10, the user must pull the tab 32, to break the frangible members 26 that define the tear strip 28. Pulling on the tab 32 splits the protective cap 10. This separates the projections 22 from the threads 24a and allows the cap 10 to be removed from the valve stem 24. Customers seeing an undamaged protective cap 10 on the valve stem 24 thus know that the propane tank operatively connected to the valve stem 24 is full and has not been tampered with.

While the invention has been described in conjunction with the specific embodiments described above, various improvements, modifications and/or substitutions are possible. Accordingly, the exemplary embodiments of the invention as set forth above are considered to be illustrative and not limiting. Various changes to the described embodiments may be made without departing from the spirit and scope of the invention.

What is claimed is:

1. A protective cap, comprising:
a protective end;
an open end;
a wall between the protective end and the open end, the wall having an internal surface;
a plurality of ribs located on the internal surface, the ribs having a tapered portion facing the open end, such that a minimum width of the ribs is at or near the open end; and
a plurality of projections, the projections having first and second ends, the first ends being connected to the internal surface of the wall.

2. The protective cap of claim 1, wherein a width of the second ends, as viewed from the open end, is greater than a width of the first ends, as viewed from the open end.

3. The protective cap of claim 1, further comprising a plurality of vent openings formed in the wall.

4. The protective cap of claim 3, wherein there are more vent openings than projections.

5. A combination, comprising:
a threaded valve stem including an external thread; and
the protective cap of claim 1, wherein the projections engage the external thread.

6. The combination of claim 5, further comprising a propane tank operatively connected to the threaded valve stem.

7. A method, comprising:
inserting a threaded valve stem into the cap of claim 1, wherein the cap further comprises a frangible member located on the wall and extending to the open end; and
breaking the frangible member to enable removal of the cap.

8. A protective cap, comprising:
a protective end;
an open end;
a wall between the protective end and the open end, the wall having an internal surface;
a plurality of projections, the projections having first and second ends, the first ends being connected to the internal surface of the wall;
a plurality of ribs located on the internal surface, wherein each rib has a radial length in a range of from about 0.8 mm to about 5.0 mm; and
a plurality of vent openings formed in the wall.

9. The protective cap of claim 8, wherein the cap further comprises a pair of frangible members located on the wall between an adjacent pair of ribs, the frangible members extending between the protective end and the open end to define a tear strip.

10. A combination, comprising:
a threaded valve stem including an external thread; and
the protective cap of claim 8, wherein the projections engage the external thread.

11. The combination of claim 10, further comprising a propane tank operatively connected to the threaded valve stem.

12. A method, comprising:
inserting a threaded valve stem into the protective cap of claim 8, wherein the cap further comprises a frangible member located on the wall and extending to the open end; and
breaking the frangible member to enable removal of the cap.

13. A protective cap that protects a threaded valve stem including an external thread and a circular opening, the cap comprising:
a protective end having (i) a central portion sized to completely, but barely, cover the circular opening, the central portion not extending as to the outer edge of a wall defining the circular opening, and (ii) a vent portion disposed radially outward from the central portion, the vent portion defining a plurality of vent openings;
an open end;
a wall between the protective end and the open end, the wall including a pair of frangible members extending between the protective end and the open end to define a tear strip, the wall further including a vent portion, the vent portion defining a plurality of vent openings;
a pull tab connected to the tear strip at the open end; and
a plurality of projections, the projections having first and second ends, the first ends being connected to an internal surface of the wall and the second ends engaging the external thread, wherein the projections prevent easy removal of the cap.

14. The protective cap of claim 13, wherein at least 20% of the area of the protective end is occupied by the vent openings.

15. The protective cap of claim 13, wherein the cap further comprises a plurality of ribs located on the internal surface, wherein:
the ribs having a tapered portion facing the open end, and
at least two ribs are located between adjacent projections.

16. A combination, comprising:
a threaded valve stem including an external thread; and
the protective cap of claim 13, wherein the projections engage the external thread.

17. The combination of claim 16, further comprising a propane tank operatively connected to the threaded valve stem.

18. A method, comprising:
inserting a threaded valve stem into the protective cap of claim 13; and
breaking the frangible members to enable removal of the cap.
